(19) United States
(12) Patent Application Publication
(10) Pub. No.: US 2010/0134057 A1
(43) Pub. Date: Jun. 3, 2010

(54) OVERVOLTAGE PROTECTION FOR A CONVERTER

(75) Inventors: Bernhard Föcking, Erlangen (DE); Guido Stöppler, Nurnberg (DE); Alexander Wagenpfeil, Rottenbach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Muenchen (DE)

(21) Appl. No.: 12/594,491

(22) PCT Filed: Apr. 4, 2008
(86) PCT No.: PCT/EP08/54083

§ 371 Date: Feb. 11, 2010

(30) Foreign Application Priority Data
Apr. 5, 2007 (DE) 10 2007 016 637.2

(51) Int. Cl. H02H 7/09

(52) U.S. Cl. 318/400.22

(57) ABSTRACT

The invention relates to a method for protecting against over voltage that is simple to produce, economical, compact and is simultaneously effective against over voltage for a converter (8) provided for supplying an electric motor (1) comprising at least one motor phase (L1, L2, L3). Said converter comprises an electric intermediate circuit (10) and several half-bridges (13a, 13b, 13c) that are connected in parallel in the intermediate circuit and respectively comprise a circuit breaker (15a, 15b, 15c) on the high potential side and a circuit breaker (17a, 17b, 17c) on the low potential side, in addition to an intermediately connected phase connection (14a, 14b, 14c). According to the invention, an intermediate circuit voltage (Uz) is detected and the or each motor phase (L1,L2,L3) is short-circuited by controlling the circuit breaker (15a, 15b, 15c) on the high potential side or the circuit breaker (17a, 17b, 17c) on the low potential side, if the intermediate circuit voltage (Uz) exceeds a predetermined maximum value. The invention also relates to a motor module (3) that comprises the converter (8) and a protection logic (22) for carrying out said method.

The invention relates to a motor module for an electric motor, in particular a permanent-magnet synchronous motor, and to a control device which has a motor module such as this. The invention furthermore relates to a method of protection of a converter, which is intended to drive an electric motor, against overvoltage.

In the case of an electric motor as is used, by way of example, as a drive for a production machine or machine tool, a rotating-field winding is normally provided on the stator side. The rotating-field winding of the motor has one or more winding sections, generally three winding sections, and—fed with an appropriately single-phase or polyphase drive current, generally an approximately sinusoidal drive current—produces a magnetic field which revolves in the air gap between the stator and the rotor of the motor, and drives the rotor. The winding sections of the rotating-field winding, which are generally connected in star with one another, are also referred to in the following text as motor phases.

The motor phases are normally electronically commutated by means of a so-called converter circuit (referred to for short in the following text as a “converter”). Conventionally, a converter such as this comprises a so-called electrical intermediate circuit, which carries an electrical DC voltage (referred to in the following text as the intermediate circuit voltage). An associated half bridge is in each case connected in the intermediate circuit for each motor phase (in contrast to this, in the case of a single-phase electric motor, the single motor phase is connected between two half bridges). Each half bridge comprises two series-connected power switches, between which a phase connection for the associated motor phase is arranged. The power switches are normally in the form of electronic switching elements, in particular so-called IGBTs or MOSFETs. With regard to their respective arrangement with respect to the phase connection and the voltage drop in the intermediate circuit, the two power switches of a half bridge are referred to in the following text as power switches on the high-potential side and on the low-potential side. A freewheeling diode is in each case connected in parallel with each power switch and is oriented in the reverse-biased direction with respect to the voltage drop in the intermediate circuit.

In addition to the converter, a control device for an electric motor normally has control logic for driving the power switches in the converter. The control device for an electric motor furthermore normally has a regulation component which generates a control signal, which is in turn supplied as an input variable to the control logic, by monitoring an operating variable of the electric motor, normally the motor current or the rotation speed.

In order to achieve a modular design, the converter with the associated control logic on the one hand and the regulation component on the other hand are also produced as mutually separate assemblies. The assembly comprising the converter and the control logic is in this case referred to as a motor module.

During operation of the electric motor, the voltage induced by rotation of the rotor in the stator windings is proportional to the rotation speed of the motor and to the magnetic flux linkages, which represent a measure of the magnitude of the magnetic field in the air gap between the rotor and the stator.

If the strength of the magnetic flux linkages is approximately constant, as is the case in particular in a permanent-magnet rotor, the induced voltage is therefore approximately proportional to the rotation speed of the motor.

Particularly in the case of a motor which is designed for high rotation speeds, the induced voltage may in this case reach high values which, without suitable protective measures, would lead to damage to a conventional converter. In order to prevent the induced voltage from exceeding a maximum permissible value, an electric motor is normally operated in a so-called weak-field mode at high rotation speeds. In this case, current is passed through the motor phases such that the stator produces a magnetic field with a field component which opposes the rotor magnetic field, thus weakening the magnetic field in the air gap between the rotor and the stator.

However, if the motor control fails, the induced voltage in the motor is in general connected to the intermediate circuit via the freewheeling diodes of the converter, without being weakened. Suitable measures must therefore be taken in order to prevent the converter from being damaged or destroyed in this case by the voltage induced in the motor.

In addition to the converter, a so-called voltage protection model (VPM) in the form of an electrical circuit connected between the motor phases is normally provided for this purpose. A voltage protection module such as this, as is known by way of example from DE 298 13 080 U1, is formed essentially by six diodes and a thyristor connected between them, wherein the motor phases can be short-circuited to one another by switching on the thyristor. The thyristor is driven via an evaluation circuit in the voltage protection module, as a function of the voltage that exists in the motor phases.

The invention is based on the object of specifying overvoltage protection, which can be implemented easily and at low cost, is compact and is at the same time effective, for a converter which is intended to supply an electric motor.

With regard to a motor module, this object is achieved by the features of claim 1. With regard to a method of protection of the converter against overvoltage, the object is achieved according to the invention by the features of claim 15.

The invention provides, in the case of a converter of the type described above, for the intermediate circuit voltage to be detected and, in the event of an overvoltage—specifically when the intermediate circuit voltage exceeds a predetermined maximum value—for the power switches on the high-potential side or the power switches on the low-potential side of all the half bridges in the converter to be switched on. Switching on the power switches on the high-potential side and those on the low-potential side results in the motor phase or phases of an electric motor which is connected to the converter being short-circuited, thus decreasing the intermediate circuit voltage.

The operating state of the converter in which the power switches on the high-potential side or those on the low-potential side of all the half bridges are switched on is correspondingly referred to for short in the following text as a “short-circuit”. Thus, in the case of a “short-circuit”, such as this, the motor phases are short-circuited, but not the intermediate circuit. If the short-circuit is formed via the power switches on the high-potential side, then the power switches on the low-potential side are correspondingly switched off at the same time, and vice versa. “Switched on” in this case refers to an operating state of a power switch in which the relevant power switch is electrically conductive. “Switched off” correspondingly refers to an operating state of a power switch in which the relevant power switch does not conduct.

In principle, the invention can be used both for a single-phase electric motor and for a polyphase electric motor. Just for simplicity reasons, the following text refers exclusively to the motor phases in the plural. This also covers the special case of a single motor phase.

The invention achieves effective overvoltage protection by suitably switching on the power switches, which are necessarily present in any case, in the converter, in such a way that the overvoltage protection, at least to a major extent, does not require any additional hardware components. This makes it possible to produce a simple, low-cost and compact control device.

In particular, protection logic is provided in order to carry out the overvoltage protection method. In this case, “logic” refers in particular to a software module which is implemented in an associated hardware component, in particular a controller. However, the protection logic can furthermore also be formed by a logic circuit.

In one advantageous embodiment to the invention, the control logic is integrated in the motor module. This results in particularly high reliability, with a simple design at the same time.

In order to prevent the intermediate circuit voltage from collapsing in the event of a fault—particularly after the external voltage supply to the intermediate circuit has collapsed—in one advantageous embodiment of the method according to the invention, the short-circuit is removed when the intermediate circuit voltage is below a predetermined minimum value. After removing the short-circuit, the intermediate circuit is charged again by the current induced in the motor. This embodiment of the method is particularly advantageous for embodiments of the motor module according to the invention in which the motor module is supplied with voltage—within the module or via an external supply component—from the intermediate circuit. The short-circuit is expediently imposed again when the intermediate circuit voltage once again exceeds the predetermined maximum voltage.

In one preferred embodiment of the invention, the power switches of the converter are configured, that is to say designed, such that they can permanently carry the short-circuit currents which are expected to occur during the short-circuit, without damage.

As an alternative to this, or for safety, one advantageous development of the invention additionally provides, with regard to such a configuration, that the short-circuit current be detected and the short-circuit be interrupted when the measured short-circuit current exceeds a predetermined maximum value. The short-circuit is in this case preferably only temporarily interrupted until the short-circuit current has decreased. The short-circuit is therefore produced intermittently. The short-circuit can be interrupted for all motor phases. In an alternative variant of the invention, the short-circuit current is in contrast detected separately for each motor phase, and the short-circuit is interrupted only for the relevant motor phase or phases in the event of an overcurrent.

Additionally, or as an alternative to this, a further advantageous embodiment of the invention provides for a decision variable to be determined, which is characteristic of the temperature of one or more of the power switches which are switched on during the short-circuit. In this case, according to the method, the short-circuit is interrupted when this decision variable exceeds a predetermined maximum value. In this case, the temperatures of the operated power switches themselves, an average or maximum temperature derived from these temperatures, or a variable which is correlated with this temperature, in particular which is proportional to this temperature, can optionally be used as the decision variable. The temperatures are in this case either measured or modeled in advantageous method variants, that is to say they are calculated on the basis of a predetermined temperature model, in particular on the basis of the time profile of the currents flowing through the switched-on power switches.

In this method variant as well, the short-circuit is expediently interrupted only temporarily, until the relevant power switches have cooled down sufficiently. The short-circuit is therefore once again produced intermittently. In alternative method variants, the short-circuit is once again interrupted either for all the motor phases or for each relevant motor phase separately.

Instead of interrupting the short-circuit completely when there is a threat of the power switches overheating, according to one alternative method variant, a change is made alternately between the power switches on the high-potential side and the power switches on the low-potential side in order to form the short-circuit. This change optionally takes place at predetermined time intervals, wherein the length of these time intervals can optionally vary as a function of further parameters, for example the magnitude of the short-circuit current. As an alternative to this, the temperature of the switched-on power switches or a decision variable which is correlated with it is once again determined, and the change is carried out only when the temperature or decision value exceeds a predetermined maximum value, and there is therefore actually a threat of overheating of the power switches which are switched on at that time.

In one preferred embodiment of the motor model, the protection logic, and therefore the overvoltage protection method carried out by it, can be reversibly activated and deactivated by presetting a switching signal. This characteristic makes it possible to also use the motor module for controlling motors in which the overvoltage protection is not necessary or would even be damaging. The latter relates, for example, to asynchronous motors.

In this case, the control logic is expediently designed to check the switching signal at predetermined, in particular regular, time intervals. In the case of a control device which comprises the motor module and an additional regulation module, this switching signal is preferably made available by the regulation module.

The control logic is expediently designed to store the respective most recent value of the switching signal. The control logic uses this stored value to autonomously decide whether the overvoltage protection method should or should not be carried out during starting and when no switching signal is transmitted.

Exemplary embodiments of the invention will be explained in more detail in the following text with reference to a drawing, in which:

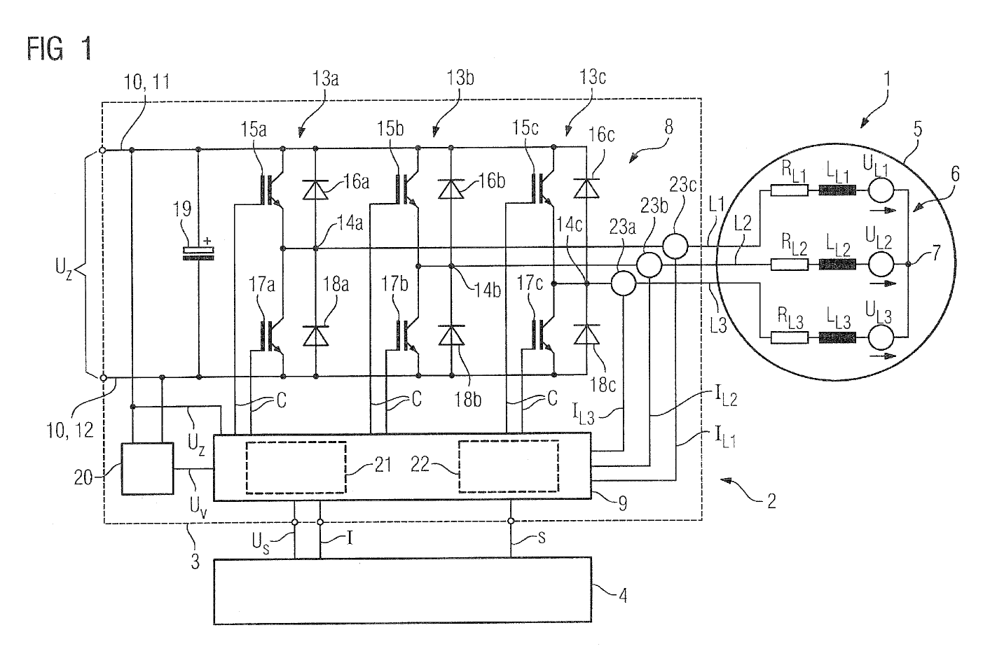

FIG. 1 shows a schematic block diagram of an electric motor having an associated control device which comprises a motor module and a regulation module,

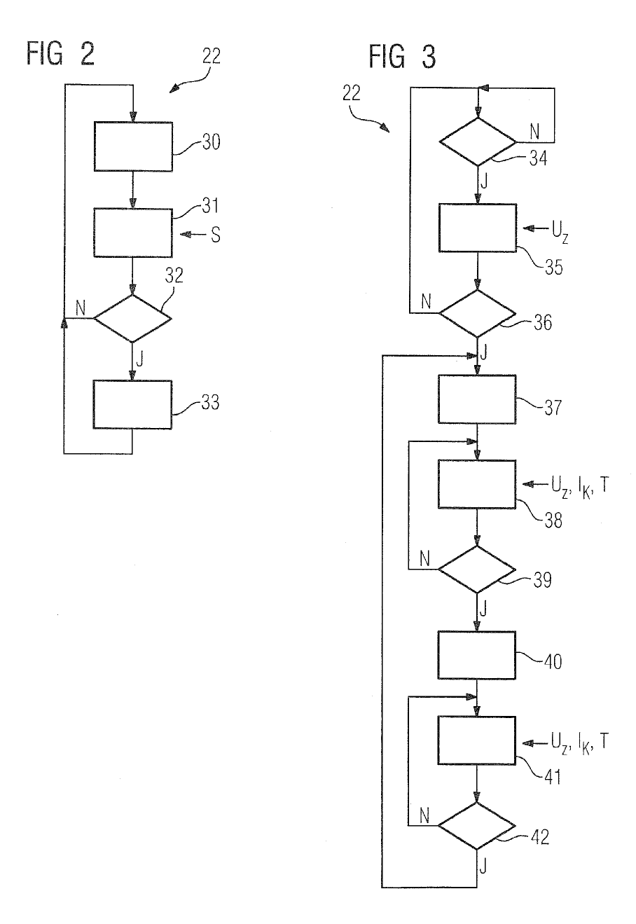

FIG. 2 shows a flowchart of a first program part of protection logic, which is implemented in the motor module, for activation and deactivation of an overvoltage protection method as a function of a switching signal,

FIG. 3 shows a flowchart of a second program part of the protection logic for carrying out the actual overvoltage protection method, and

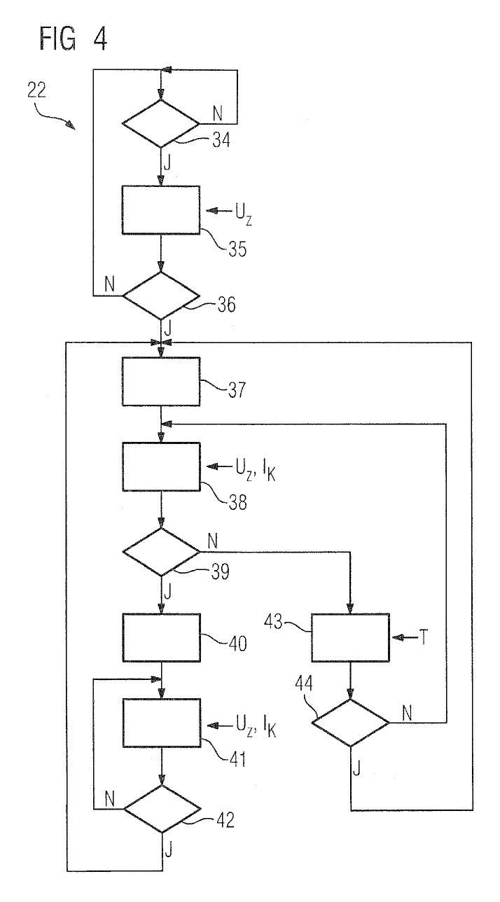

FIG. 4 uses an illustration corresponding to FIG. 3 to show an alternative embodiment of the second program part of the protection logic.

Mutually corresponding parts, variables and structures are always provided with the same reference symbols in all the figures.

FIG. 1 shows, roughly schematically, an (electric) motor 1 in the form of a permanent-magnet synchronous motor, which is provided as a drive for a production machine or machine tool. FIG. 1 also shows a control device 2 for supplying a drive current to the motor 1. The control device 2 in this case has two mutually separate assemblies, specifically a motor module 3 and a regulation module 4.

The motor 1 comprises a stator 5 (which is indicated only schematically in the illustration), which is wound with a rotating-field winding 6. The rotating-field winding 6 comprises three winding sections, referred to in the following text as motor phases L1, L2 and L3, which are connected together at a star point 7. The physical characteristics of each motor phase L1, L2, L3 are characterized by an inductance L_{L1}, L_{L2}, L_{L3}, resistors R_{L1}, R_{L2}, R_{L3}, and an induced voltage U_{L1}, U_{L2}, U_{L3}. The inductances L_{L1}, L_{L2}, L_{L3}, resistances R_{L1}, R_{L2}, R_{L3} and voltages U_{L1}, U_{L2}, U_{L3} are shown in the form of an equivalent circuit in FIG. 1.

The motor module 3 comprises a converter 8 and a control unit 9. The converter 8 comprises an electrical intermediate circuit 10 with a high-potential side 11 and a low-potential side 12, between which an intermediate circuit voltage U_{Z} is present during operation of the motor 1.

In the intermediate circuit 10, three half bridges 13a, 13b, 13c are connected in parallel in order to feed a respective motor phase L1, L2, L3. Each half bridge 13a, 13b, 13c has a phase connection 14a, 14b, 14c to which the associated motor phase L1, L2, L3 is connected. The motor phase L1 is therefore connected to the phase connection 14a of the half bridge 13a, the motor phase L2 to the phase connection 14b of the half bridge 13b, and the motor phase L3 to the phase connection 14c of the half bridge 13c.

Between the respective phase connection 14a, 14b, 14c and the high-potential side 11 of the intermediate circuit 10, each half bridge 13a, 13b, 13c has a power switch 15a, 15b, 15c on the high-potential side, in particular in the form of an IGBT. A freewheeling diode 16a, 16b, 16c is respectively connected in parallel with each of these power switches 15a, 15b, 15c. Within each half bridge 13a, 13b, 13c, a respective power switch 17a, 17b, 17c on the low-potential side is connected between the motor connection 14a, 14b, 14c and the low-potential side 12 of the intermediate circuit 10. Each of the power switches 17a, 17b, 17c on the low-potential side is once again in particular in the form of an IGBT, and is flanked by a parallel-connected freewheeling diode 18a, 18b, 18c.

The converter 8 furthermore has a capacitor 19, which is connected in parallel with the half bridges 13a, 13b, 13c in the intermediate circuit 10, in order to compensate for voltage ripple during operation of the motor 1.

The control unit 9 is formed by a microcontroller, or has at least one such microcontroller. The control unit 9 is supplied via a module-internal voltage supply unit 20 with a supply voltage U_{V} of typically 24 volts. In this case the voltage supply unit 20 is itself fed from the intermediate circuit 10.

Control logic 21 and protection logic 22 are implemented in the form of software modules in the control unit 9. The control unit 9 switches the power switches 15a, 15b, 15c on or off during operation of the motor 1 in accordance with a control method that is predetermined by the control logic 21, by emitting respectively associated control signals C, in order to produce phase currents I_{L1}, I_{L2}, I_{L3}, which produce a rotating field, in the motor phases L1, L2 and L3. The phase currents I_{L1}, I_{L2}, I_{L3} are tapped off by current measurement devices 23a, 23b, 23c, with measured values of these phase currents (for simplicity reasons likewise referred to as I_{L1}, I_{L2}, I_{L3}) being supplied as an input variable to the control unit 9. The control unit 9 is also supplied with the intermediate circuit voltage U_{Z} or a measured value that is proportional to it, as an input variable.

The regulation module 4 contains regulation logic (which is not illustrated in any more detail), which regulates the rotation speed and/or power of the motor 1 on the basis of a predetermined regulation variable. In this case, the motor current, in particular, is used as the regulation variable. In this case, the control unit 9 uses the measured phase currents I_{L1}, I_{L2}, I_{L3} to calculate a current actual value I, and supplies this as an input variable to the regulation module 4. On the basis of a comparison of the current actual value I with a stored current nominal value, the regulation module 4 produces a voltage nominal value U_{S} as an output variable, and feeds this back to the control unit 9. The control logic 21 produces the control signals C on the basis of this voltage nominal value U_{S} and the measured motor currents I_{L1}, I_{L2}, I_{L3}.

During operation of the motor 1, the protection logic 22 monitors the intermediate circuit voltage U_{Z} and, in the event of an overvoltage, short-circuits the motor phases L1, L2, L3 via the intermediate circuit 10 by selectively switching on either all the power switches 15a, 15b, 15c on the high-potential side or all the power switches 17a, 17b, 17c on the low-potential side. In order to allow the motor module 3 to also be used, in contrast to the described embodiment, with motors in which there is no need for such overvoltage protection or this would even be damaging—for example with an asynchronous motor instead of the synchronous motor—the method carried out by the protection logic 21 can be reversibly activated and deactivated by presetting an appropriate switching signal S. This switching signal S is made available as an input variable to the control unit 9, and therefore to the protection logic 22, by the regulation module 4.

The method carried out by the protection logic 22 will be described in more detail using a first exemplary implementation, on the basis of FIGS. 2 and 3. In this embodiment, the protection logic 22 is subdivided into two program parts, of which a first program part, which is illustrated in FIG. 2, checks the value of the switching signal S at regular time intervals, while a second program part, which is illustrated in FIG. 3, carries out the actual overvoltage protection method.

The first program part, as shown in FIG. 2, is started in a first step 30 with a timer function or the like, at regular time intervals. The switching signal S is checked in a subsequent step 31. The protection logic 22 checks in a subsequent step 32 whether it has been possible for the switching signal S to be read correctly. If this is not the case (N), then the program procedure returns to step 30 and, after a waiting time has elapsed, repeats the reading process. Otherwise (J), that is to say if the reading process is correct, the new value of the switching signal S that has been read is stored in step 33, after which the program procedure returns to step 30 again.

The second program part, which is illustrated in FIG. 3, of the protection logic 22 in principle operates autonomously and independently of the first program part. This ensures that the overvoltage protection is also provided when it has not been possible to read an up-to-date value of the switching signal S, for example that is to say in the event of failure of the regulation module, when the data link to it is faulty, or during starting of the control device 2.

In a first step 34 of the program part as shown in FIG. 3, a check is first of all carried out, by checking the value of the switching signal S stored in the control unit 9, to determine whether the overvoltage protection method should be activated. If this is not the case (N), then step 34 is carried out again. Otherwise (J), the protection logic 22 determines the value of the intermediate circuit voltage U_{Z}, in a subsequent step 35. A check is carried out in a subsequent step 36 to determine whether the value of the intermediate circuit voltage U_{Z} which has been detected in this way is greater than a predetermined maximum voltage U_{Zmax} (U_{Z}>U_{Zmax}). If this is not the case (N), then the program procedure returns to step 34. Otherwise, in step 37, the protection logic 22 produces a short-circuit between the motor phases L1, L2, L3 by switching on all the power switches 15a, 15b, 15c on the high-potential side.

As a consequence of the short-circuit, the intermediate circuit voltage U_{Z} decreases successively. In this case, subsequent steps 38 to 42 ensure that the intermediate circuit voltage U_{Z}, and therefore the supply voltage U_{V} to the control unit 9 as well, do not collapse as a result of the short-circuit, and that the power switches 15a, 15b, 15c which have been switched on are not overloaded.

For this purpose, the intermediate circuit voltage U_{Z} is once again detected first of all in step 38. Then, in step 38, a value is determined for the short-circuit current I_{K} flowing through the switched-on power switches 15a, 15b, 15c, and a decision variable T is determined for the temperature of the switched-on power switches 15a, 15b, 15c. The protection logic 22 in this case determines the short-circuit current I_{K} on the basis of the measured phase currents I_{L1}, I_{L2}, I_{L3}. In particular, the maximum value of the phase currents I_{L1}, I_{L2}, I_{L3} is used as the short-circuit current I_{K}, while the decision variable T is determined on the basis of a stored temperature model of the power switches 15a, 15b, 15c by detection with respect to time, in particular integration, of the phase currents I_{L1}, I_{L2}, I_{L3}.

In step 39, the protection logic 22 uses the following decision rule:

U_{Z}<U_{Z,max} OR I_{K}>I_{K,max} OR T>Tₘₐₓ,

to check whether the intermediate circuit voltage U_{Z}, the short-circuit current I_{K} or the decision variable T is or are less than or greater than stored threshold values U_{Z,max}, I_{K,max}, Tₘₐₓ. As long as this is not the case (N), steps 38 and 39 are repeated.

Otherwise (J), the short-circuit is removed in step 40, by switching off the power switches 15a, 15b, 15c.

Removal of the short-circuit has the effect that the short-circuit current I_{K} decreases and the power switches 15a, 15b, 15c, which are switched on for the short-circuit, cool down. The removal of the short-circuit also has the consequence that—provided that the motor 1 is still rotating—the intermediate circuit voltage U_{Z} increases again, as a result of the induction effect in the motor 1.

In step 41, the intermediate circuit voltage U_{Z}, the short-circuit current I_{K} (which now flows via the freewheeling diodes 16a, 16b, 16c and 18a, 18b, 18c) and the decision variable T are determined again and, in step 42, they are once again compared with stored threshold values, using the decision rule:

U_{Z}>U_{Z,max} AND I_{K}<I_{K,max} AND T<Tₘₐₓ

As long as this decision rule is not satisfied (N), steps 41 and 42 are repeated. As soon as the opposite situation (J) is found, in which the decision variable T is less than the associated threshold value Tₘₐₓ and the short-circuit current I_{K} is less than the associated maximum current I_{K,max}, the short-circuit is created again by jumping back to step 37—provided that the intermediate circuit voltage U_{Z} is greater than the associated maximum value U_{Z,max} again.

In particular when the motor 1 is externally rotated over a relatively long time, in such a way that the induced voltages U_{L1}, U_{L2}, U_{L3} are sufficient to keep the intermediate circuit voltage U_{Z} at a value which permanently exceeds the maximum value U_{Z,max}, steps 37 to 42 are carried out repeatedly. The short-circuit will therefore operate intermittently in order on the one hand to permanently force the intermediate circuit voltage U_{Z} below the maximum value U_{Z,max}, while at the same time preventing overloading of the power switches 15a, 15b, 15c which are switched on for the short-circuit.

FIG. 4 shows a variant of the second program part as shown in FIG. 3 which—unless stated to the contrary in the following text—is the same as the program procedure described above.

In contrast to the embodiment shown in FIG. 3, however, the protection logic 22 in the variant shown in FIG. 4 is designed to always form the short-circuit in step 37 alternately via the power switches 15a, 15b, 15c on the high-potential side or via the power switches 17a, 17b, 17c on the low-potential side. Furthermore, in steps 38 and 41, only the intermediate circuit voltage U_{Z} and the short-circuit current I_{K} are determined, and in step 39 only these variables are compared with stored threshold values using the decision rule:

U_{Z}<U_{Z,max} OR I_{K}>I_{K,max}

In the case of an undervoltage (U_{Z}<U_{Z,max}) or an overcurrent (I_{K}>I_{K,max}), the short-circuit is interrupted in step 40, analogously to the method described in conjunction with FIG. 3. As a consequence of step 42, the short-circuit is produced again when the condition

U_{Z}>U_{Z,max} AND I_{K}<I_{K,max}

is satisfied.

The decision variable T for the temperature of the switched-on power switches 15a, 15b, 15c and 17a, 17b, 17c is determined in step 43 only in the situation in which the threshold-value comparison carried out in step 39 has a negative result (N). In this case, a check is carried out in a subsequent step 44 to determine whether the decision variable T is greater than the stored threshold value Tₘₐₓ (T>Tₘₐₓ). If not (N), then the monitoring of the intermediate circuit voltage U_{Z}, of the short-circuit current I_{K} and of the decision variable T is continued by jumping back to step 38. Otherwise, the program procedure returns to step 37, as a result of which the short-circuit is produced once again via the power switches 15a, 15b, 15c and 17a, 17b, 17c which were respectively previously switched off.

On the basis of the characteristic of the program variant illustrated in FIG. 4, of producing the short-circuit alternately in step 37 via the power switches 15a, 15b, 15c on the high-potential side or via the power switches 17a, 17b, 17c on the low-potential side, if overheating of the power switches 15a, 15b, 15c and 17a, 17b, 17c (T>Tₘₐₓ) is found this is maintained without any significant interruption, just by switching between the power switches 15a, 15b, 15c on the high-potential side and the power switches 17a, 17b, 17c on the low-potential side in order to produce the short-circuit. In contrast, in the event of an undervoltage in the intermediate circuit (U_{Z}<U_{Zmin}) and in the event of an overcurrent (I_{K}>I_{K,max}), the short-circuit is operated intermittently, in addition to the change on the half bridge side.

In one preferred embodiment, the protection logic 22 identifies when the critical operating range has been left, and in this case reverts to normal operation. The identification is flanked in that the regulation module 4 guarantees or confirms maintenance of the non-critical state (for example by pulse extinguishing). If, for example, the rotation speed of the motor 1 has been decreased to such an extent that the induced voltage U_{L1}, U_{L2}, U_{L3} is less than the intermediate circuit voltage, the regulation module 4 ensures that the rotation speed is kept in this non-critical range, until the protection logic 22 is ready again.

1.-22. (canceled)

23. A motor module for an electric motor having at least one motor phase, comprising:
a converter comprising an electrical intermediate circuit and a plurality of half bridges connected in parallel in the intermediate circuit, each of the half bridges having a first power switch on a high-potential side and a second power switch on a low-potential side connected in series with the first power switch, and a phase connection connected to the series connection between the first and second power switch, and
a protection logic configured to detect an intermediate circuit voltage and to switch on the first power switch or the second power switch so as to short-circuit the at least one motor phase or each motor phase when the intermediate circuit voltage exceeds a predetermined maximum value.

24. The motor module of claim 23, wherein the protection logic is configured to remove the short-circuit when the intermediate circuit voltage is below a predetermined minimum value.

25. The motor module of claim 23, wherein the protection logic is configured to determine a short-circuit current flowing through at least one of the switched-on power switches and to interrupt the short-circuit for the associated motor phase when the short-circuit current exceeds a predetermined maximum value.

26. The motor module of claim 23, wherein the protection logic is configured to determine a decision variable representative of a temperature of at least one of the switched-on power switches, and to interrupt the short-circuit for the associated motor phase when the decision variable exceeds a predetermined maximum value.

27. The motor module of claim 23, wherein the protection logic is configured to alternately switch on the first power switch and the second power switch in order to form the short-circuit.

28. The motor module of claim 27, wherein the protection logic is configured to determine a decision variable representative of a temperature of at least one of the switched-on power switches, and to change between the first power switch and on second power switch in order to form the short-circuit when the decision variable exceeds a predetermined maximum value.

29. The motor module of claim 26, wherein the protection logic is configured to determine the decision variable on the basis of a time profile of the current flowing through at least one of the switched-on half bridges.

30. The motor module of claim 28, wherein the protection logic is configured to determine the decision variable on the basis of a time profile of the current flowing through at least one of the switched-on half bridges.

31. The motor module of claim 26, wherein the temperature is a measured temperature measured on at least one of the switched-on first and second power switches.

32. The motor module of claim 28, wherein the temperature is a measured temperature measured on at least one of the switched-on first and second power switches.

33. The motor module of claim 23, further comprising a voltage supply which is fed from the intermediate circuit.

34. The motor module of claim 23, wherein the first and second power switches are rated so as to be capable of permanently sustaining an expected short-circuit current without being damaged.

35. The motor module of claim 23, wherein the protection logic is configured to be reversibly activatable and deactivatable by a switching signal.

36. The motor module of claim 35, wherein the protection logic is configured to check the switching signal at predetermined time intervals.

37. A control device for an electric motor fed by at least one motor phase, comprising:
a motor module with
a converter comprising an electrical intermediate circuit and a plurality of half bridges connected in parallel in the intermediate circuit, each of the half bridges having a first power switch on a high-potential side and a second power switch on a low-potential side connected in series with the first power switch, and a phase connection connected to the series connection between the first and second power switch, and
a protection logic configured to detect an intermediate circuit voltage and to switch on the first power switch or the second power switch so as to short-circuit the at least one motor phase or each motor phase when the intermediate circuit voltage exceeds a predetermined maximum value, and
a regulation module connected to the motor module and configured to control the motor module based of an operating variable of the electric motor.

38. The control device of claim 37, wherein the operating variable is a motor current or a rotation speed of the electric motor.

39. The control device of claim 37, wherein the regulation module is configured to supply to the protection logic at predetermined time intervals a switching signal that reversibly activates and deactivates the protection logic.

40. A method for protecting a converter driving an electric motor with at least one motor phase against overvoltage, wherein the converter comprises a converter with an electrical intermediate circuit and a plurality of half bridges connected in parallel in the intermediate circuit, each of the half bridges having a first power switch on a high-potential side and a second power switch on a low-potential side connected in series with the first power switch, and a phase connection connected to the series connection between the first and second power switch, said method comprising the steps of:
detecting an intermediate circuit voltage, and
short-circuiting the at least one motor phase or each motor phase by switching on all first power switches or all second power switches when the detected intermediate circuit voltage exceeds a predetermined maximum value.

41. The method of claim 40, further comprising the step of removing the short-circuit when the detected intermediate circuit voltage falls below a predetermined minimum value.

42. The method of claim 40, further comprising the steps of detecting a short-circuit current flowing through at least one of the switched-on power switches, and interrupting the short-circuit for an associated motor phase when the short-circuit current exceeds a predetermined maximum value.

43. The method of claim 40, further comprising the steps of determining a decision variable representative of a temperature of at least one of the switched-on power switches, and interrupting the short-circuit for an associated motor phase when the decision variable exceeds a predetermined maximum value.

44. The method of claim 40, further comprising the step of alternately switching on the first and second power switches in order to form the short-circuit.

45. The method of claim 40, further comprising the steps of determining a decision variable representative of a temperature of at least one of the switched-on power switches, and changing between the first and second power switches in order to form the short-circuit when the decision variable exceeds a predetermined maximum value.

46. The method of claim 43, wherein the decision variable is determined based a time profile of currents flowing through the switched-on half bridges.

47. The method of claim 45, wherein the decision variable is determined based a time profile of currents flowing through the switched-on half bridges.

48. The method of claim 43, wherein the decision variable is a measured temperature of the switched-on power switches.

49. The method of claim 45, wherein the decision variable is a measured temperature of the switched-on power switches.
